(19) United States
(12) Patent Application Publication
(10) Pub. No.: US 2012/0254219 A1
(43) Pub. Date: Oct. 4, 2012

(54) BOOLEAN SEARCH QUERY SYSTEM, METHOD AND COMPUTER READABLE MEDIA

(76) Inventor: Elise Bell, Burtonsville, MD (US)

(21) Appl. No.: 13/076,124

(22) Filed: Mar. 30, 2011

(51) Int. Cl. G06F 17/30

(52) U.S. Cl. 707/766; 707/E17.074

(57) ABSTRACT

A system, method and computer readable media for generating Boolean search queries based on a graphical user interface are disclosed. The system can provide a graphical user interface and extract search terms and relationship control element values from the graphical user interface. The system can generate a Boolean query string based on the search terms and control values. The Boolean query string can be used to query a database. The Boolean query string can be used to generate a search query agent.

Embodiments relate generally to computerized information searching and, more particularly, to systems, methods and computer readable media for generating and searching computer databases using Boolean search queries automatically generated from information provided via a graphical user interface.

In an embodiment, a system for generating database search queries includes a processor and a nontransitory computer readable medium coupled to the processor. The nontransitory computer readable medium has program instructions stored on it that, when executed by the processor, cause the processor to perform operations. The operations can include providing a graphical user interface for inputting one or more search terms and for graphically selecting a Boolean relationship between the one or more search terms, and receiving a signal from the graphical user interface indicating that a search is requested. The operations can also include extracting, in response to the signal, search terms and relationship control settings from control elements within the graphical user interface, and generating a Boolean search query based on the extracted terms and relationship control settings. The operations can further include expanding the Boolean search query to include synonyms of search terms, the synonyms being retrieved from a dictionary associated with the database, and querying the database using the expanded Boolean search query. The operations can also include providing results retrieved from the database based on the expanded Boolean search query.

In another embodiment, a computerized method for searching a database includes providing, with a processor programmed to perform database queries, a graphical user interface for inputting one or more search terms and for graphically selecting a Boolean relationship between the one or more search terms, and receiving, at the processor, a signal from the graphical user interface indicating that a search is requested. The method can also include extracting, at the processor in response to the signal, search terms and relationship control settings from control elements within the graphical user interface, and generating, with the processor, a Boolean search query based on the extracted terms and relationship control settings. The method can further include querying the database using the Boolean search query, and providing results retrieved from the database based on the Boolean search query as output from the processor.

Another embodiment includes a nontransitory computer readable medium having stored thereon software instructions that, when executed by a processor, cause the processor to perform operations. The operations can include providing, with a processor programmed to perform database queries, a graphical user interface for inputting one or more search terms and for graphically selecting a Boolean relationship between the one or more search terms, and receiving, at the processor, a signal from the graphical user interface indicating that a search is requested. The operations can also include extracting, at the processor in response to the signal, search terms and relationship control settings from control elements within the graphical user interface and generating, with the processor, a Boolean search query based on the extracted terms and relationship control settings. The operations can further include expanding the Boolean search query to include synonyms of search terms, and querying the database using the expanded Boolean search query. The operations can also include providing results retrieved from the database based on the expanded Boolean search query as output from the processor, and providing an interface control element with the results to permit a software agent to be created from the expanded Boolean search query, the software agent being adapted to retrieve results based on the expanded search query periodically from the database and to provide the results as output.

### BRIEF DESCRIPTION OF THE DRAWINGS

FIG. 1 is a diagram of an exemplary graphical user interface for Boolean searching (or querying) in accordance with the present disclosure.

FIG. 2 is a diagram of an exemplary graphical user interface for presenting stored search queries and allowing a user to select from among the stored search queries, in accordance with the present disclosure.

FIG. 3 is a diagram of an exemplary graphical user interface for presenting search query results in accordance with the present disclosure.

FIG. 4 is a chart showing an exemplary method for processing associated with a Boolean search graphical user interface in accordance with the present disclosure.

FIG. 5 is a chart showing an exemplary method for generating a Boolean search graphical user interface in accordance with the present disclosure.

FIG. 6 is a diagram of a system for generating a Boolean search query graphical user interface and processing queries and presenting results.

### DETAILED DESCRIPTION

While embodiments shown in the figures, and described below, relate to conducting Boolean searches for job-related information on a job posting board, resume bank or the like, it will be appreciated that the Boolean search query system, method and computer readable media disclosed herein can be applied to numerous areas of information searching such as academic research, consumer or business purchasing searches, real estate listing searches, web site searches, classified ads selling anything, auction listings, vacation rentals or the like. In general, an embodiment can be used for any type of information where searching using Boolean operators may be desirable.

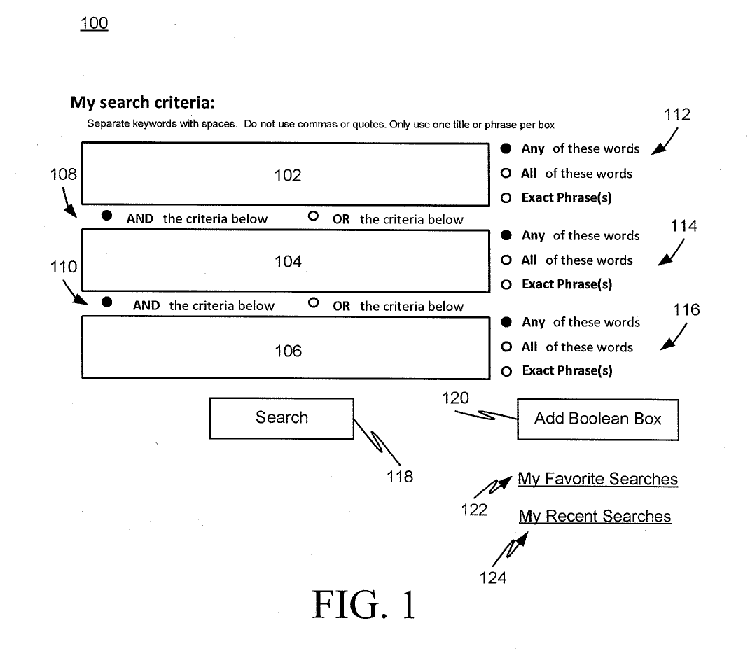

FIG. 1 shows a graphical user interface (GUI) 100 having a plurality of text boxes (102-106) and groups of radio buttons 108 and 110. The GUI 100 also includes three groups of radio buttons (112-116), each corresponding to one of the text boxes (102-106). The GUI 100 further includes a search button 118, an “Add Boolean Box” button 120, a “My Favorite Searches” link 122 and a “My Recent Searches” link 124.

In operation, a system generates the GUI 100 and transmits it for display on a display device visible to a user. The user can then conduct a search of a database by entering one or more words or symbols into one of the text boxes (102-106) and selecting a radio button from among the applicable groups of radio buttons (108-110 and 112-116). Once the user has entered the desired words or phrases into the text boxes (102-106) and made the desired radio button selections from among the radio button groups (108-116), the system can extract the words, phrases and radio button selections from the GUI 100 and automatically generate a Boolean search string for querying an information source (e.g., a database, search engine, web site, document, or the like).

The groups of radio buttons (108 and 110) disposed between text boxes 102 and 104, and 104 and 106, respectively, serve to indicate a desired relationship between the query strings generated from the respective text boxes. The groups of radio buttons (112-116) disposed to the right of the text boxes (102-106) serve to indicate a desired relationship among the words or phrases within each respective text box. For example, assume a user were to enter “database oracle” in the first text box (102) and select the “All of these words” radio button from the radio button group (112) adjacent to the first text box 102. Further assume the user were to select the “AND the criteria below” from the group of radio buttons (108) disposed between the first text box 102 and the second text box 104; then the user were to enter “Java J2EE” in the second text box (104); and then the user were to select the “Any of these words” radio button from the group of radio buttons (114) adjacent to the second text box (104). The system would be programmed to automatically generate a Boolean search string similar to the following: (database AND oracle) AND (Java OR J2EE).

The radio button “Exact Phrase(s),” shown in the radio buttons groups (112-116) to the right of each text box, is used to indicate that a set of words should be searched as an exact phrase (e.g., a job title, product name, or the like), for example by placing quotation marks around the phrase in the Boolean search query string. For example, assuming a user selects the “Exact Phrase(s)” radio button in each of the radio button groups (112 and 114) adjacent to the first two search boxes (102 and 104) and enters the words “database administrator” in the first text box (102) and enters the words “sq1 server” in the second text box 104, and selects the “AND” radio button from the group of radio buttons (108) in between the first and second text boxes. Also assuming the user enters the words “java and J2EE” in the third text box 106 and selects the “Any of these words” radio button from the group of radio buttons (116) adjacent to the third text box (106), the system would generate a query string similar to the following: “database administrator” AND “SQL Server” AND (Java or J2EE). In a GUI implementation for a specific type of search the “Exact Phrase(s)” label may be replaced with a phrase indicating a specific type of exact phrase, such as “Job Title(s)” for a job posting board or resume bank system.

Also, the system can be programmed to permit users to enter Boolean operators (e.g., “OR”, “AND”, “XOR” (exclusive OR), “NOT” or other Boolean operators) between key words in the text boxes. When the “exact Phrase(s) radio button is selected, the system can be programmed to auto-populate open quotes after each occurrence of a space following a Boolean operator entered by the user. The system can also be programmed to auto populate end quote marks immediately following a phrase when the user enter a space and a Boolean operator, and also when the end (or limit) of the Boolean query box is reached.

If a user fails to enter a Boolean operator in between multiple keywords after choosing the Exact Phrase option, the system can be programmed to recognize that there are multiple phrases and no Boolean operators, the system can prompt the user to enter a Boolean operator in between the multiple Exact Phrases that are in one Boolean box.

Also, the system can be programmed to permit users to enter quote marks in order to achieve mixed queries, such as (Oracle OR “SQL Server”) AND (Javascript OR “Java Script”).

The graphical user interface can include an additional radio button for entering mixed queries (i.e., those with exact phrase and other keywords entered) and can permit users to type in quotes. The graphical user interface can include an indication to the user telling the user that typing quote marks around phrases is permitted.

In addition to performing a Boolean search using a query string automatically generated from the GUI 100, a user could select the “Add Boolean Box” button 120 to add an additional text box (similar to 102-104) to accommodate lengthier queries. A user of a Boolean search system could select the “My Favorite Searches” link 122 or the “My Recent Searches” link 124 to bring up a GUI showing stored favorite searches or recent searches, respectively.

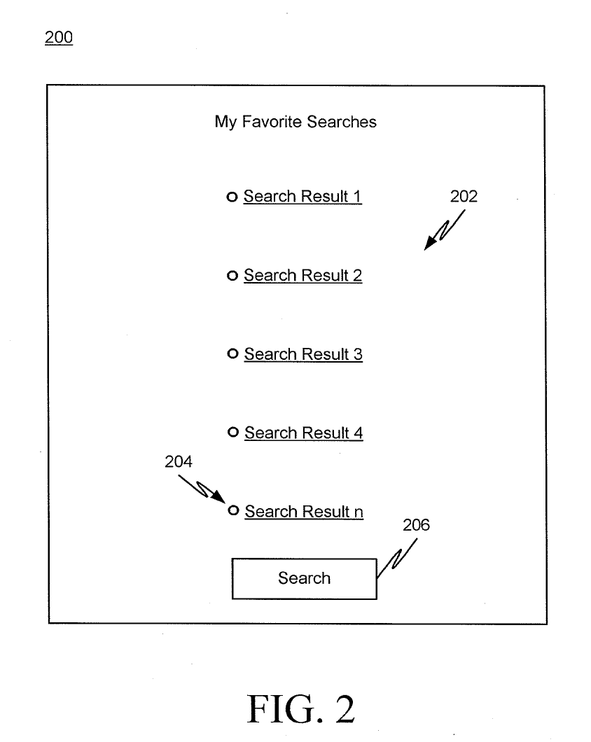

FIG. 2 shows a graphical user interface (GUI) 200 for presenting stored search queries and allowing a user to select from among the stored search queries. The GUI 200 includes a listing of stored searches 202. The stored search listing can be in the form of a list of hypertext links that perform the search when the user selects one of the links. Alternatively, the GUI 200 could include a radio button (204) or other element to indicate a selection of a stored search query and then a button (206) to perform the search according to the selected stored query. When storing queries, a user could provide a name for the query that is recognizable to the user and which can provide an indication of the nature of the query. For example, a user could name the query “Java AND Developer” as “Java Developer Job.”

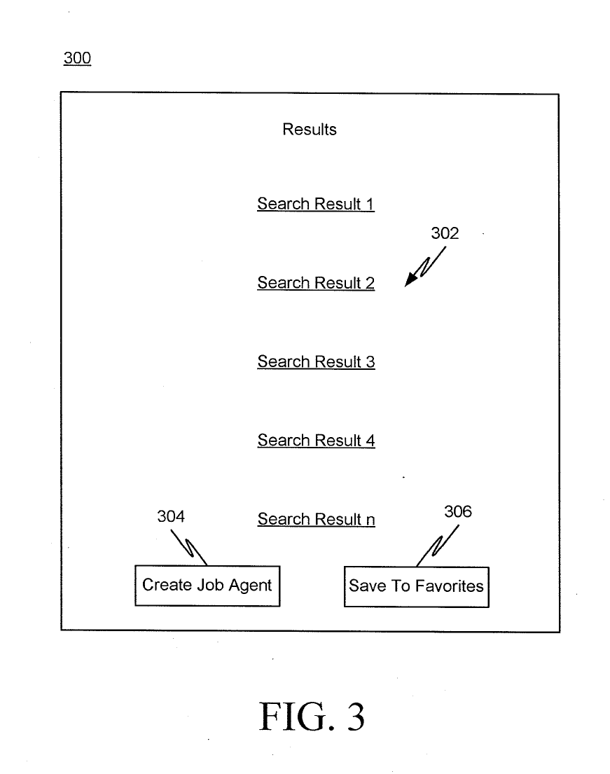

FIG. 3 is a diagram of an exemplary graphical user interface (GUI) 300 for presenting search query results. The GUI 300 includes a listing of search results 302 and a “Create Job Agent” button 304 and a “Save to Favorites” button 306.

In operation, the GUI 300 is presented after a search query has been performed. The results displayed in the GUI 300 represent those results that matched (or were close to matching) the query. The number of results presented in the GUI 300 depends on the number of matches (or near matches) found in the database or information source being queried. The GUI 300 can be a multi-page GUI in such cases as when the number of search results exceeds the display area of the GUI.

When a user selects the “Create Job Agent” button 304, the system can transform the search query string into a job agent. The job agent can be an automated task or query that repeatedly (either continuously or at intervals) monitors the database for new results matching the query upon which the job agent is based. The job agent can then alert the user (e.g., via email, instant message, text message, phone call, or the like) that new results matching the search query have been found.

When a user selects the “Save to Favorites” button 306, the query is saved to the favorites list (e.g., the list shown when a user selects link 122 in FIG. 1). As mentioned above the user can name the stored query.

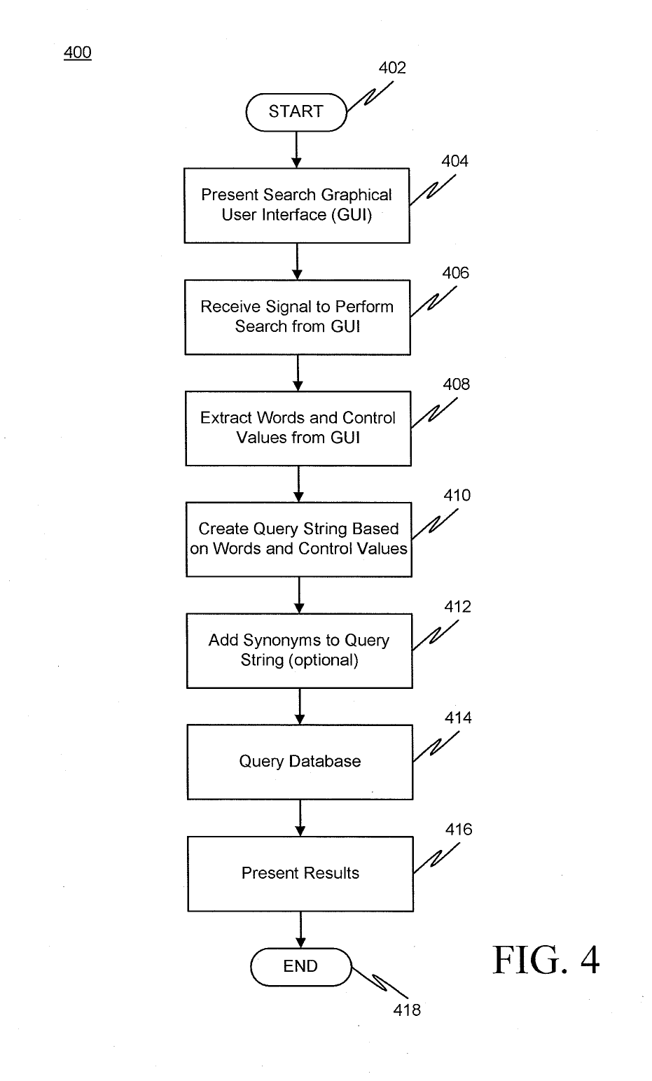

FIG. 4 is a chart showing an exemplary method 400 for processing associated with a Boolean search graphical user interface in accordance with the present disclosure. Processing begins at 402 and continues to 404.

At 404, a Boolean search graphical user interface (e.g., similar to 100 of FIG. 1) is presented. Once the GUI is presented, a user can enter information and make interface control selections. Processing continues to 406.

At 406, a signal is received to process a search according to the information in the GUI. This signal can be generated for example when the user selects the “Search” button (e.g., 118 of FIG. 1). Processing continues to 408.

At 408, the words, phrases and control values are extracted from the GUI. Variables or other data structures can be used to store the words, phrases and control values. Processing continues to 410.

At 410, the words, phrases and control values are processed to automatically create a Boolean search string in which the Boolean operators are based on the control value selections (e.g., radio button selections) described above in connection with FIG. 1. Processing continues to 412.

At 412, synonyms are optionally automatically added to the Boolean search string. For example, if a user entered the phrase “oracle database administrator” in a text box, the system could automatically add the phrases “oracle dba” and “oracle database admin” to the Boolean query string as synonyms. Processing continues to 414.

At 414, the database (or other information source) is queried using the automatically generated Boolean search string. Processing continues to 416.

At 416, results of the query are presented (e.g., using a GUI as shown in FIG. 3). Processing continues to 418, where processing ends.

It will be appreciated that 404-416 can be repeated in whole or in part in order to accomplish a contemplated Boolean search task.

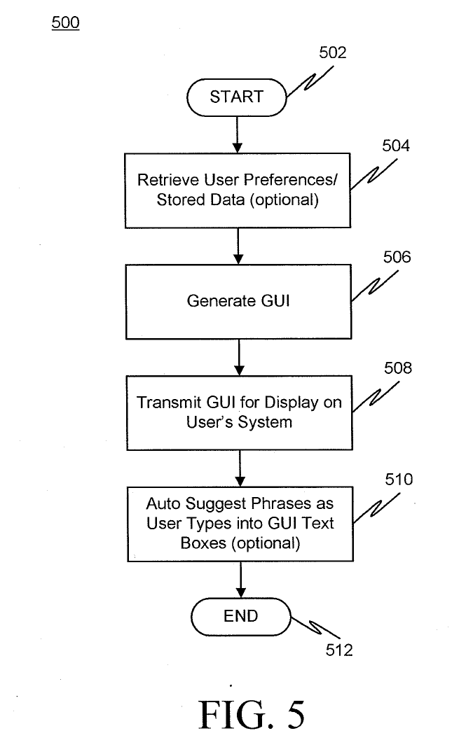

FIG. 5 is a chart showing an exemplary method 500 for generating a Boolean search graphical user interface in accordance with the present disclosure. Processing begins at 502 and continues to 504.

At 504, stored user preference data is optionally retrieved. The data can be retrieved, for example, using a cookie or other token stored in the user's system. Alternatively, the user could login through a login procedure and the system could retrieve stored data based upon the validated login identity of the user. The use of stored data is optional and can provide an enhanced user experience by permitting the system to retain preferences of each user as well as stored search queries, recent search queries. Also, stored user preference data could be used to automatically reconfigure a basic GUI to conform to typical usage patterns of the user. For example, if a user regularly adds Boolean search boxes when performing a search, the system could automatically present a GUI to that user with additional search boxes already present. Processing continues to 506.

At 506, the GUI (e.g., 100 of FIG. 1) is generated. If user preference and/or stored data is available, then the GUI can optionally be presented based on that data. Generating the GUI can include generating basic elements, recent searches or a link to recent searches, favorite searches or a link to favorite searches, hyperlinks for automatically inserting frequently typed words, and additional Boolean boxes. Processing continues to 508.

At 508, the GUI is transmitted to the user's system for display. This can include transmitting mark-up language code (e.g., HTML, XML or the like), graphical images, Flash animation data, or the like. Alternatively, the system could transmit data that informs an application (e.g., an app running on a mobile device or on a PC) running on the user's system on how to generate the GUI. Processing continues to 510.

At 510, the GUI can optionally include a feature for auto text completion. For example, if a user enters “Oracle,” the system could suggest “oracle database administrator,” “oracle dba,” “oracle database admin,” “oracle developer,” “oracle ERP systems integration,” or the like. The auto text information can come from a dictionary of terms (general, field-specific or both) or from the words a user (or other users) have previously entered, or both. Processing continues to 512.

At 512, processing ends. It will be appreciated that 504-510 can be repeated in whole or in part in order to accomplish a contemplated GUI display operation.

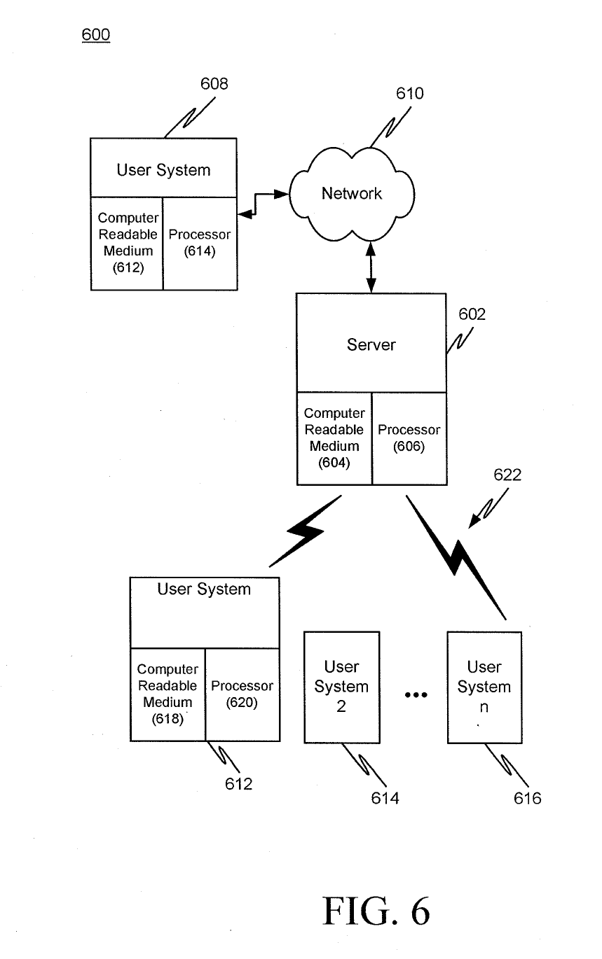

FIG. 6 is a diagram of an exemplary system for generating a Boolean search query graphical user interface and processing queries and presenting results. FIG. 6 shows a system 600 having a server computer 602 (with a nontransitory computer readable medium 604 and a processor 606), a user system 608 (with a nontransitory computer readable medium 612 and a processor 614) and a network 610 coupling the server computer 602 and the user system 608. The system 600 can also optionally include other user systems 612-616. Each user system 612-616 having a nontransitory computer readable medium and processor (as shown in 612 as 618 and 620 respectively, but not shown in the others for simplicity). The other user systems 612-616 can communicate with the server via link 622.

The server computer 602 can include a single server computer, a distributed server computer, a cloud computing system or any computing system suitable for performing server functions. In general, any computing device capable of being programmed to perform server function in accordance with the present disclosure can be used.

The user systems (608 and 612-616) can be a wireless phone (e.g., an Apple iPhone, a feature phone, a smart phone or the like), a personal digital assistant (e.g., a Blackberry, a Palm Pilot, a Windows Mobile device or the like), a portable computer (e.g., a laptop, netbook, notepad computer, tablet computer, Apple iPad, palm top computer or the like), an ebook reader (e.g., Amazon Kindle, Barnes and Noble Nook, Sony ebook reader or the like), a portable media player (e.g., Apple iTouch or the like), a desktop computer (e.g., a PC-compatible, an Apple Macintosh, Unix-based system or the like) or other suitable computing device. In general, any computing device capable of being programmed to perform the seller device and/or buyer device functions in accordance with the present disclosure and as described herein can be used.

Each nontransitory computer readable medium mentioned above (604, 612 and 618) can include RAM, ROM, EEPROM, flash memory, CD, DVD, magnetic disc drive, optical disc drive, electronic memory and/or any now known or later developed computer readable medium suitable for storing instructions and/or data.

Each processor (606, 614 and 620) can include a microprocessor, microcontroller, digital signal processor, application specific integrated circuit, programmable logic device and/or the like.

The network 610 and link 622 can each include one or more of a local area network, a wide area network, the Internet, a virtual private network, a wireless network (WiFi, cellular, Bluetooth or the like), a wired network or the like.

In operation, a user (e.g., an individual searching for a job posting) can use the user system 608 to access the server 602. The software for the accessing the server can be executed from the user system 608 nontransitory computer readable medium 612. The software can be, for example, an application (or “app”) that is downloaded from an online application marketplace such as that provided for the iPhone, Android, Blackberry and Palm wireless devices. Alternatively, or in addition to an application, the software can be provided from the server computer 602 in the form of software as a service or as a web service. The user can use the user system 608 to view the Boolean search GUI (as described above) and to perform searches using the GUI presented by the server 602. The GUI and search results can be displayed on a display device coupled to, or integrated with, the user systems.

It will be appreciated that the modules, processes, systems, and sections described above can be implemented in hardware, hardware programmed by software, software instructions stored on a nontransitory computer readable medium or a combination of the above. A system for Boolean searching, for example, can include using a processor configured to execute a sequence of programmed instructions stored on a nontransitory computer readable medium. For example, the processor can include, but not be limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C++, C#.net or the like. The instructions can also comprise code and data objects provided in accordance with, for example, the Visual Basic™ language, or another structured or object-oriented programming language. The sequence of programmed instructions and data associated therewith can be stored in a nontransitory computer-readable medium such as a computer memory or storage device which may be any suitable memory apparatus, such as, but not limited to ROM, PROM, EEPROM, RAM, flash memory, disk drive and the like.

Furthermore, the modules, processes systems, and sections can be implemented as a single processor or as a distributed processor. Further, it should be appreciated that the steps mentioned above may be performed on a single or distributed processor (single and/or multi-core). Also, the processes, system components, modules, and sub-modules described in the various figures of and for embodiments above may be distributed across multiple computers or systems or may be co-located in a single processor or system. Exemplary structural embodiment alternatives suitable for implementing the modules, sections, systems, means, or processes described herein are provided below.

The modules, processors or systems described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and a software module or object stored on a computer-readable medium or signal, for example.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any processor capable of implementing the functions or steps described herein can be used to implement embodiments of the method, system, or a computer program product (software program stored on a nontransitory computer readable medium).

Furthermore, embodiments of the disclosed method, system, and computer program product may be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a VLSI design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the function description provided herein and with a general basic knowledge of the user interface and/or computer programming arts.

Moreover, embodiments of the disclosed method, system, and computer program product can be implemented in software executed on a programmed general purpose computer, a special purpose computer, a microprocessor, or the like.

It is, therefore, apparent that there is provided, in accordance with the various embodiments disclosed herein, computer systems, methods and software for conducting Boolean searches of an information source.

While the invention has been described in conjunction with a number of embodiments, it is evident that many alternatives, modifications and variations would be or are apparent to those of ordinary skill in the applicable arts. Accordingly, Applicant intends to embrace all such alternatives, modifications, equivalents and variations that are within the spirit and scope of the invention.

What is claimed is:

1. A system for generating database search queries, the system comprising:
a processor and a nontransitory computer readable medium coupled to the processor,
the nontransitory computer readable medium having stored thereon program instructions that, when executed by the processor, cause the processor to perform operations including:
providing a graphical user interface for inputting one or more search terms and for graphically selecting a Boolean relationship between the one or more search terms;
receiving a signal from the graphical user interface indicating that a search is requested;
extracting, in response to the signal, search terms and relationship control settings from control elements within the graphical user interface;
generating a Boolean search query based on the extracted terms and relationship control settings;
expanding the Boolean search query to include synonyms of search terms, the synonyms being retrieved from a dictionary associated with the database;
querying the database using the expanded Boolean search query; and
providing results retrieved from the database based on the expanded Boolean search query.

2. The system of claim 1, wherein the graphical user interface control elements include a plurality of text boxes and a plurality of relationship control elements.

3. The system of claim 2, wherein the plurality of relationship control elements are divided into a first group and a second group, the first group including relationship control elements corresponding to relationship control among search terms in a text box and the second group including relationship control elements corresponding to relationship control between pairs of text boxes.

4. The system of claim 2, wherein the operations include auto-populating search terms in the text boxes based on text being entered into a text box and on stored search terms.

5. The system of claim 4, wherein the stored search terms are search terms that have been previously entered into the text boxes.

6. The system of claim 4, wherein the stored search terms are search terms that have been retrieved from a dictionary of terms related to information stored in the database.

7. The system of claim 1, wherein the operations further include providing an interface control element with the results to permit a software agent to be created from the expanded Boolean search query, the software agent being adapted to retrieve results based on the expanded search query periodically from the database and to provide the results as output.

8. A computerized method for searching a database, the method comprising:
providing, with a processor programmed to perform database queries, a graphical user interface for inputting one or more search terms and for graphically selecting a Boolean relationship between the one or more search terms;
receiving, at the processor, a signal from the graphical user interface indicating that a search is requested;
extracting, at the processor in response to the signal, search terms and relationship control settings from control elements within the graphical user interface;
generating, with the processor, a Boolean search query based on the extracted terms and relationship control settings;
querying the database using the Boolean search query; and
providing results retrieved from the database based on the Boolean search query as output from the processor.

9. The method of claim 8, further comprising expanding the Boolean search query to include synonyms of search terms, the synonyms being retrieved from a dictionary associated with information stored in the database.

10. The method of claim 8, wherein the graphical user interface control elements include a plurality of text boxes and a plurality of relationship control elements.

11. The method of claim 10, wherein the plurality of relationship control elements are divided into a first group and a second group, the first group including relationship control elements corresponding to relationship control among search terms in a text box and the second group including relationship control elements corresponding to relationship control between pairs of text boxes.

12. The method of claim 10, further comprising auto-populating search terms in the text boxes based on text being entered into a text box and on stored search terms.

13. The method of claim 12, wherein the stored search terms are search terms that have been previously entered into the text boxes.

14. The method of claim 12, wherein the stored search terms are search terms that have been retrieved from a dictionary of terms related to information stored in the database.

15. The method of claim 8, further comprising providing an interface control element with the result to permit a software agent to be created from the Boolean search query, the software agent being adapted to retrieve results based on the expanded search query periodically from the database and to provide the results as output.

16. A nontransitory computer readable medium having stored thereon software instructions that, when executed by a processor, cause the processor to perform operations including:
providing, with a processor programmed to perform database queries, a graphical user interface for inputting one or more search terms and for graphically selecting a Boolean relationship between the one or more search terms;
receiving, at the processor, a signal from the graphical user interface indicating that a search is requested;
extracting, at the processor in response to the signal, search terms and relationship control settings from control elements within the graphical user interface;
generating, with the processor, a Boolean search query based on the extracted terms and relationship control settings;
expanding the Boolean search query to include synonyms of search terms;
querying the database using the expanded Boolean search query;
providing results retrieved from the database based on the expanded Boolean search query as output from the processor; and
providing an interface control element with the results to permit a software agent to be created from the expanded Boolean search query, the software agent being adapted to retrieve results based on the expanded search query periodically from the database and to provide the results as output.

17. The computer readable medium of claim 16, wherein the operations further include expanding the Boolean search query to include synonyms of search terms, the synonyms being retrieved from a dictionary associated with information stored in the database.

18. The computer readable medium of claim 16, wherein the graphical user interface control elements include a plurality of text boxes and a plurality of relationship control elements.

19. The computer readable medium of claim 18, wherein the plurality of relationship control elements are divided into a first group and a second group, the first group including relationship control elements corresponding to relationship control among search terms in a text box and the second group including relationship control elements corresponding to relationship control between pairs of text boxes.

20. The computer readable medium of claim 18, further comprising auto-populating search terms in the text boxes based on text being entered into a text box and on stored search terms.
